(19) United States
(12) Patent Application Publication
(10) Pub. No.: US 2026/0321773 A1
(43) Pub. Date: Oct. 15, 2026

(54) TEMPERATURE CONTROL DEVICE AND TEMPERATURE CONTROL METHOD FOR ELECTRICAL ENERGY STORAGE DEVICE

(71) Applicant: Prime Planet Energy & Solutions, Inc., Tokyo (JP)

(72) Inventor: Takanori SOEJIMA, Toyota-shi (JP)

(21) Appl. No.: 19/645,293

(22) Filed: Apr. 13, 2026

(30) Foreign Application Priority Data
Apr. 14, 2025 (JP) 2025-065982

(51) Int. Cl. H01M 10/633; B60L 58/26; B60L 58/27; H01M 10/613; H01M 10/615; H01M 10/625; H01M 10/6561

(52) U.S. Cl. CPC H01M 10/633; H01M 10/613; H01M 10/615; H01M 10/625; H01M 10/6561; B60L 58/26; B60L 58/27; B60L 2240/545; H01M 2220/20

(57) ABSTRACT

A temperature control device for an electrical energy storage device disclosed herein includes a first determination unit that determines whether the electrical energy storage device is on fast charging, a temperature acquisition unit that acquires the temperature of the electrical energy storage device, a second determination unit that determines whether the temperature acquired by the temperature acquisition unit is more than an upper-limit temperature, and a temperature control unit that causes a temperature regulation mechanism to cool the electrical energy storage device in a case where both determination results of the first determination unit and the second determination unit are yes.

### CROSS REFERENCE TO RELATED APPLICATION

This application claims the benefit of priority to Japanese Patent Application No. 2025-065982 filed on Apr. 14, 2025. The entire contents of this application are hereby incorporated herein by reference.

### BACKGROUND OF THE DISCLOSURE

### 1. Field

The present disclosure relates to a temperature control device and a temperature control method for an electrical energy storage device.

### 2. Background

Electrical energy storage devices have been widely used for electric vehicles such as a battery electric vehicle and a hybrid electric vehicle. From the viewpoints of enhancing the performance of the electrical energy storage devices sufficiently or suppressing the deterioration thereof, various techniques for controlling the electrical energy storage devices have been suggested (for example, see Japanese Patent Application Publication No. 2023-152429, Japanese Patent Application Publication No. 2020-149880, Japanese Patent Application Publication No. 2020-098712, and Japanese Patent Application Publication No. 2020-156148).

### SUMMARY

An electrical energy storage device may be charged with large current in a short time, that is, charged in a so-called fast charging mode. In this case, in a high-capacity electrical energy storage device that is to be mounted on an electric vehicle, the absolute value of current increases and the amount of heat generation increases in accordance with Joule's Law (Q=I²R). Thus, the temperature of the electrical energy storage device tends to become high in the fast charging. The present inventor's examination has pointed out that when the temperature of the electrical energy storage device becomes too high in the fast charging, the salt concentration becomes uneven in an electrode assembly, causing the internal resistance to increase temporarily and the capacity to decrease, that is, reversible high-rate deterioration is easily caused.

The present disclosure has been made in view of such a circumstance, and a main object thereof is to provide a temperature control device and a temperature control method for an electrical energy storage device, capable of suppressing the reversible high-rate deterioration as described above.

The present disclosure provides a temperature control device for an electrical energy storage device, and the temperature control device is electrically connected to a temperature regulation mechanism that regulates a temperature of the electrical energy storage device. The temperature control device includes a first determination unit that determines whether the electrical energy storage device is on fast charging in which charging is performed with a predetermined charging current or more, a temperature acquisition unit that acquires the temperature of the electrical energy storage device, a second determination unit that determines whether the temperature acquired by the temperature acquisition unit is more than a predetermined upper-limit temperature, and a temperature control unit that causes the temperature regulation mechanism to cool the electrical energy storage device in a case where both determination results of the first determination unit and the second determination unit are yes.

In addition, the present disclosure provides a temperature control method for an electrical energy storage device in electric connection to a temperature regulation mechanism that regulates a temperature of the electrical energy storage device. The temperature control method includes a first determining step of determining whether the electrical energy storage device is on fast charging in which charging is performed with a predetermined charging current or more, a temperature acquiring step of acquiring the temperature of the electrical energy storage device, a second determining step of determining whether the temperature acquired by the temperature acquiring step is more than a predetermined upper-limit temperature, and a temperature controlling step of causing the temperature regulation mechanism to cool the electrical energy storage device in a case where both determination results of the first determining step and the second determining step are yes.

In the present disclosure, by controlling so that the temperature of the electrical energy storage device will not become too high in the fast charging, the increase of internal resistance can be suppressed and the reversible high-rate deterioration of the electrical energy storage device can be suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic view illustrating an electric vehicle and one example at the time of charging the electric vehicle;

FIG. 2 is a function block diagram of a temperature control device according to one embodiment;

FIG. 3 is a flowchart showing one example of a control process; and

FIG. 4 is a graph showing transition of resistance in Comparative Example and Example.

### DETAILED DESCRIPTION OF THE PREFERRED EMBODIMENTS

Hereinafter, preferred embodiments of the art disclosed herein will be described with reference to the drawings. Meanwhile, matters that are other than matters particularly mentioned in the present specification and that are necessary for the implementation of the art disclosed herein can be grasped as design matters of those skilled in the art based on the prior art in the relevant field. The art disclosed herein can be implemented on the basis of the contents disclosed in the present specification and common technical knowledge in the relevant field.

### Temperature Control Device for Electrical Energy Storage Device

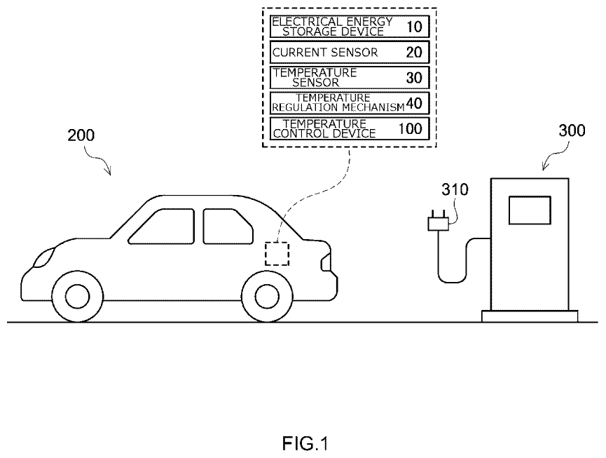

FIG. 1 is a schematic view illustrating an electric vehicle 200 and one example at the time of charging the electric vehicle 200. In the example illustrated here, charging is performed using a charging stand 300 (charging station) as an external power source. The charging stand 300 is equipped with a charging cable 310. The charging cable 310 is one of charging cables for charging with relatively small current, that is, so-called for “normal charging” or charging cables for charging with larger current than in the normal charging, that is, so-called for “fast charging”. At the charging, the charging cable 310 has its plug connected to the electric vehicle 200.

The electric vehicle 200 is, for example, a passenger car such as a battery electric vehicle (BEV) or a hybrid electric vehicle (HEV). In another embodiment, however, the electric vehicle 200 may be a vehicle other than the passenger car, such as a truck or a bus. In addition, the hybrid electric vehicle may be a plug-in hybrid electric vehicle (PHEV). Although the illustration is omitted, the electric vehicle 200 according to this embodiment includes a port to connect the charging cable 310 for the normal charging, and a port to connect the charging cable 310 for the fast charging, and is configured to be able to deal with the fast charging. The electric vehicle 200 incorporates an electrical energy storage device 10, a current sensor 20, a temperature sensor 30, a temperature regulation mechanism 40, and a temperature control device 100. However, the current sensor 20 is not essential and can be omitted in another embodiment.

The electrical energy storage device 10 is a motive power source for a motor (power source for driving) of the electric vehicle 200. The electrical energy storage device 10 is configured to be chargeable by an external power source such as the charging stand 300 here. The electrical energy storage device 10 is mounted on the electric vehicle 200 typically in a mode of an electrical energy storage module in which a plurality of the electrical energy storage devices 10 are electrically connected to each other. The electrical energy storage device 10 is typically monitored and controlled by a battery monitoring unit (BMU) of the electric vehicle 200. The electrical energy storage device 10 is here configured to be able to deal with the charging with relatively small current, that is, “a normal charging mode” and the charging with larger current than in the normal charging mode, that is, “a fast charging mode”.

Note that the term “electrical energy storage device” in this specification refers to general devices that can be repeatedly charged and discharged, and is a concept that encompasses a secondary battery such as a lithium ion secondary battery or a nickel hydrogen battery, and a capacitor such as a lithium ion capacitor, a pseudo-capacitor, or an electrical double-layer capacitor.

The electrical energy storage device 10 is a secondary battery here, and specifically a lithium ion secondary battery. The electrical energy storage device 10 is configured in such a way that an electrode assembly and an electrolyte, which are not illustrated, are accommodated in a battery case. The structure of the electrical energy storage device 10 may be similar to the conventional one without particular limitations. The electrical energy storage device 10 can be a square battery with a rectangular parallelepiped shape. The battery case can include an upper surface (a first surface) in a substantially rectangular shape where electrode terminals (a positive electrode terminal and a negative electrode terminal) are provided, a pair of long side surfaces facing each other, a pair of short side surfaces facing each other, and a lower surface (a second surface) facing the upper surface.

The current sensor 20 is to detect the current (charging current I) applied to the electrical energy storage device 10. The current sensor 20 is connected to a current circuit, which is not illustrated, of the electrical energy storage device 10, for example. The structure of the current sensor 20 is not limited in particular. The current sensor 20 includes, for example, an electronic component, an electronic appliance, or the like with a function of measuring the current that has conventionally been known. The current sensor 20 is electrically connected to the temperature control device 100.

The temperature sensor 30 is to detect a temperature T of the electrical energy storage device 10. The temperature sensor 30 is attached to an outer surface of the electrical energy storage device 10, for example. In one example, the temperature sensor 30 is attached to one surface (for example, the upper surface where the electrode terminals are provided) of the battery case of the electrical energy storage device 10. The structure of the temperature sensor 30 is not limited in particular. The temperature sensor 30 includes, for example, a resistance thermometer (thermistor), a thermocouple, or the like. The temperature sensor 30 is electrically connected to the temperature control device 100.

The temperature regulation mechanism 40 is to regulate the temperature of the electrical energy storage device 10 at least when the electrical energy storage device 10 is on the fast charging. The temperature regulation mechanism 40 may regulate the temperature of the electrical energy storage devices 10 individually or may regulate the temperature of the plurality of electrical energy storage devices 10 (electrical energy storage module) collectively. The structure of the temperature regulation mechanism 40 is not limited in particular. The temperature regulation mechanism 40 regulates the temperature of the electrical energy storage device 10 using a heat exchange medium, for example. The temperature regulation mechanism 40 has both a cooling function of cooling the electrical energy storage device 10 and a heating function of heating the electrical energy storage device 10 here. The heating function, however, is not essential and can be omitted in another embodiment. Moreover, the cooling function and the heating function may be achieved by different mechanisms in another embodiment. The temperature regulation mechanism 40 is electrically connected to the temperature control device 100.

In some embodiments, the temperature regulation mechanism 40 is of an air-cooling type. The temperature regulation mechanism 40 may include an air blower (fan), and may be configured to cool the electrical energy storage device 10 by blowing air with the heat released in the heat exchanger to an internal space of a housing that accommodates the plurality of electrical energy storage devices 10 (electrical energy storage module) or to heat the electrical energy storage device 10 by blowing air heated in the heat exchanger (for example, electric heater).

In some other embodiments, the temperature regulation mechanism 40 is of a liquid-cooling type. The temperature regulation mechanism 40 includes a temperature control plate disposed in contact with one surface (for example, the lower surface facing the upper surface where the temperature sensor 30 is provided) of the battery case of the electrical energy storage device 10, for example. The temperature regulation mechanism 40 may be configured to cool the electrical energy storage device 10 by passing liquid with the heat released in the heat exchanger to a temperature control plate or to heat the electrical energy storage device 10 by passing liquid heated in the heat exchanger (for example, electric heater) to the temperature control plate.

The temperature control device 100 is a device that controls the temperature of the electrical energy storage device 10. The temperature control device 100 is a device that manages the temperature of the electrical energy storage device 10 mounted on the electric vehicle 200 here. One example of the temperature control device 100 is a micro-computer, although the structure thereof is not limited in particular. For example, the micro-computer may include an interface (I/F) that receives data and the like from an external appliance, a central processing unit (CPU) that executes instructions of programs, a read only memory (ROM) that stores the programs to be executed by the CPU, a random access memory (RAM) that is used as a working area to develop the programs, and a storage unit such as a memory that stores the programs and various kinds of data. The temperature control device 100 can be included in the BMU of the electric vehicle 200.

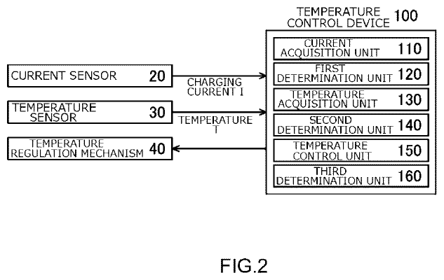

FIG. 2 is a function block diagram of the temperature control device 100. As illustrated in FIG. 2, the temperature control device 100 according to this embodiment is electrically connected to the current sensor 20, the temperature sensor 30, and the temperature regulation mechanism 40, and is configured to be able to control these. The temperature control device 100 according to this embodiment includes a current acquisition unit 110, a first determination unit 120, a temperature acquisition unit 130, a second determination unit 140, a temperature control unit 150, and a third determination unit 160. However, the current acquisition unit 110 and the third determination unit 160 are not essential and can be omitted partially or entirely in another embodiment.

The current acquisition unit 110 is configured to acquire the charging current I of the electrical energy storage device 10 by controlling the current sensor 20. The first determination unit 120 is configured to determine whether the electrical energy storage device 10 is on the fast charging in which the charging is performed with a predetermined charging current or more (a lower-limit charging current Iₘᵢₙ or more). The first determination unit 120 is configured to determine whether the fast charging is currently performed, based on the charging current I acquired by the current acquisition unit 110 here. Specifically, the first determination unit 120 is configured to determine that the fast charging is currently performed when the charging current I is the lower-limit charging current Iₘᵢₙ or more. Using an actual measurement value makes it possible to determine whether the fast charging is currently performed more accurately.

The lower-limit charging current Iₘᵢₙ is stored in advance in the temperature control device 100. The lower-limit charging current Iₘᵢₙ is a value that can fully charge the electrical energy storage device 10 within an hour (more preferably within 30 minutes) typically, and is determined in advance on the basis of a preliminary experiment. In one example, the first determination unit 120 may be configured to determine that the fast charging is currently performed when the charging current I is about 100 A or more and preferably 200 A or more (for example, 200 A to 500 A), although there is no particular limitation because these values can vary depending on the capacity or the like of the electrical energy storage device 10, for example. In the case where the absolute value is large in this manner, the amount of heat generation in the fast charging tends to become very large and in particular, the temperature of the electrical energy storage device 10 tends to become higher. Accordingly, it is particularly preferable to apply the art disclosed herein.

The temperature acquisition unit 130 is configured to acquire the temperature T of the electrical energy storage device 10 by controlling the temperature sensor 30. The second determination unit 140 is configured to determine whether the temperature T acquired by the temperature acquisition unit 130 is more than a predetermined upper-limit temperature (Tₘₐₓ). The upper-limit temperature Tₘₐₓ is stored in advance in the temperature control device 100. The upper-limit temperature Tₘₐₓ is determined in advance by the preliminary experiment on the basis of a relation between the temperature T of the electrical energy storage device 10 and the increase of the internal resistance, for example. In some embodiments, the upper-limit temperature Tₘₐₓ is preferably set in the range of 40±5 °C from the viewpoint of achieving the effect of the art disclosed herein at a higher level. In one example, the upper-limit temperature Tₘₐₓ is set to preferably 40 °C and more preferably 35 °C.

The temperature control unit 150 is configured to control the temperature regulation mechanism 40 on the basis of determination results of the first determination unit 120 and the second determination unit 140 so as to regulate the temperature of the electrical energy storage device 10. Specifically, the temperature control unit 150 is configured to cause the temperature regulation mechanism 40 to cool the electrical energy storage device 10 when the determination result of the first determination unit 120 is “Yes” (it is determined that the predetermined fast charging is currently performed) and the determination result of the second determination unit 140 is “Yes” (it is determined that the temperature T is more than the predetermined upper-limit temperature Tₘₐₓ). This makes the temperature of the electrical energy storage device 10 lower than the upper-limit temperature Tₘₐₓ, which is a threshold on a high temperature side. By controlling so that the temperature of the electrical energy storage device 10 will not become too high in the fast charging, the increase of the internal resistance can be suppressed and the reversible high-rate deterioration of the electrical energy storage device 10 can be suppressed.

For example, the temperature control unit 150 may control the temperature regulation mechanism 40 so as to cool the electrical energy storage device 10 until the temperature measured by the temperature sensor 30 becomes less than the upper-limit temperature Tₘₐₓ, or may control the temperature regulation mechanism 40 so as to cool the electrical energy storage device 10 only for a predetermined period of time.

In some embodiments, the temperature control unit 150 may be configured, in the case where the first determination unit 120 has determined that the predetermined fast charging is not performed currently and/or the second determination unit 140 has determined that the temperature is not more than the predetermined upper-limit temperature Tₘₐₓ (is less than or equal to the upper-limit temperature Tₘₐₓ), not to regulate the temperature of the electrical energy storage device 10 (not to drive the temperature regulation mechanism 40 or keep the status quo). According to the present inventor's examination, even if the temperature of the electrical energy storage device 10 becomes too low in the fast charging, the internal resistance may increase to easily cause the high-rate deterioration, although this problem is not remarkable compared to the case in which the temperature is more than the upper-limit temperature Tₘₐₓ. Therefore, by skipping the temperature regulation, the effect of the art disclosed herein can be easily achieved stably. In addition, the control can be made efficient.

The third determination unit 160 is configured to determine whether the temperature T acquired by the temperature acquisition unit 130 is less than a predetermined lower-limit temperature (Tₘᵢₙ). The lower-limit temperature Tₘᵢₙ is stored in advance in the temperature control device 100. The lower-limit temperature Tₘᵢₙ is determined in advance by the preliminary experiment on the basis of the relation between the temperature T of the electrical energy storage device 10 and the increase of the internal resistance, for example. In some embodiments, the lower-limit temperature Tₘᵢₙ is preferably set in the range of 10±5 °C from the viewpoint of achieving the effect of the art disclosed herein stably at a higher level. In one example, the lower-limit temperature Tₘᵢₙ is set to preferably 5 °C and more preferably 15 °C

In this embodiment, the temperature control unit 150 is configured to further control the temperature regulation mechanism 40 on the basis of the determination results of the first determination unit 120 and the third determination unit 160 so as to regulate the temperature of the electrical energy storage device 10. Specifically, the temperature control unit 150 is configured to cause the temperature regulation mechanism 40 to heat the electrical energy storage device 10 when the determination result of the first determination unit 120 is “Yes” (it is determined that the predetermined fast charging is currently performed) and the determination result of the third determination unit 160 is “Yes” (it is determined that the temperature T is less than the predetermined lower-limit temperature Tₘᵢₙ). This makes the temperature of the electrical energy storage device 10 higher than the lower-limit temperature Tₘᵢₙ, which is a threshold on a low temperature side. By controlling the temperature of the electrical energy storage device 10 within the suitable range so that the temperature will not become too low in the fast charging, the increase of the internal resistance can be suppressed more accurately and the high-rate deterioration of the electrical energy storage device 10 can be suppressed stably.

For example, the temperature control unit 150 may control the temperature regulation mechanism 40 so as to heat the electrical energy storage device 10 until the temperature measured by the temperature sensor 30 becomes more than the lower-limit temperature Tₘᵢₙ, or may control the temperature regulation mechanism 40 so as to heat the electrical energy storage device 10 only for a predetermined period of time.

In some embodiments, the temperature control unit 150 may be configured, in the case where the first determination unit 120 has determined that the predetermined fast charging is not performed currently and/or the third determination unit 160 has determined that the temperature is not less than the predetermined lower-limit temperature Tₘᵢₙ (is more than or equal to the lower-limit temperature Tₘᵢₙ), not to regulate the temperature of the electrical energy storage device 10 (not to drive the temperature regulation mechanism 40 or keep the status quo). Therefore, the effect of the art disclosed herein can be easily achieved stably. In addition, the control can be made efficient.

### Temperature Control Method for Electrical Energy Storage Device

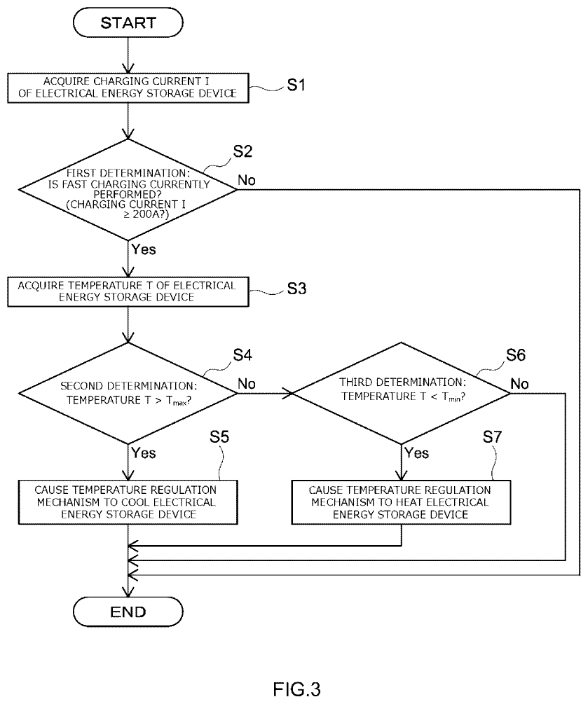

FIG. 3 is a flowchart of control of the temperature control device 100. The timing of performing this temperature control is not limited in particular; however, in some embodiments, this temperature control may be performed when the charging of the electrical energy storage device 10 is started. More specifically, in the case of charging in the charging stand 300, for example, connecting the charging cable 310 to the electric vehicle 200 causes the charging stand 300 to send a signal to the BMU of the electric vehicle 200. The temperature control may be started when the BMU has received this signal from the charging stand 300. In addition, this temperature control may be repeated periodically through predetermined intervals while the electrical energy storage device 10 is on the charging, for example. Moreover, this temperature control may be terminated when the charging of the electrical energy storage device 10 ends. Note that “Yes” means the same as affirmative and “No” means the same as negative in the following control.

In the temperature control in this embodiment, first, in step S1, the current sensor 20 is controlled by the current acquisition unit 110, so that the charging current I of the electrical energy storage device 10 is acquired. Next, in step S2, the first determination unit 120 determines whether the electrical energy storage device 10 is on the fast charging in which the charging is performed at the predetermined charging current or more. In this embodiment, it is determined that the fast charging is currently performed when the charging current I acquired by the current acquisition unit 110 is a predetermined value (lower-limit charging current Iₘᵢₙ, here 200 A) or more. In this embodiment, step S1 is one example of a current acquiring step and step S2 is one example of a first determining step.

If the electrical energy storage device 10 is not on the fast charging (the result in step S2 is NO), for example, if the electrical energy storage device 10 is on the normal charging as described above or the charging is stopped for some trouble, the control is terminated without regulating the temperature of the electrical energy storage device 10.

On the other hand, if the electrical energy storage device 10 is on the fast charging (the result in step S2 is YES), the temperature acquisition unit 130 controls the temperature sensor 30 to acquire the temperature T of the electrical energy storage device 10 in the subsequent step S3. Next, in step S4, the second determination unit 140 determines whether the temperature T of the electrical energy storage device 10 is more than the predetermined upper-limit temperature Tₘₐₓ. In this embodiment, step S3 is one example of a temperature acquiring step and step S4 is one example of a second determining step.

If the temperature T of the electrical energy storage device 10 is more than the upper-limit temperature Tₘₐₓ (the result in step S4 is YES), the temperature control unit 150 controls the temperature regulation mechanism 40 and causes the temperature regulation mechanism 40 to cool the electrical energy storage device 10 in step S5. In this embodiment, step S5 is one example of a temperature controlling step.

On the other hand, if the temperature T of the electrical energy storage device 10 is not more than the upper-limit temperature Tₘₐₓ (the result in step S4 is NO), additionally, the third determination unit 160 determines whether the temperature T of the electrical energy storage device 10 is less than the predetermined lower-limit temperature Tₘᵢₙ in step S6. If the temperature T of the electrical energy storage device 10 is less than the lower-limit temperature Tₘᵢₙ (the result in step S6 is YES), the temperature control unit 150 controls the temperature regulation mechanism 40 and causes the temperature regulation mechanism 40 to heat the electrical energy storage device 10 in step S7. In this embodiment, step S6 is one example of a third determining step and step S7 is one example of a second temperature controlling step.

On the other hand, in the case where the temperature T of the electrical energy storage device 10 is not less than the lower-limit temperature Tₘᵢₙ (the result in step S6 is NO), the control is terminated without regulating the temperature of the electrical energy storage device 10.

As described above, by the temperature control device 100 and the temperature control method for the electrical energy storage device 10 disclosed herein, the electrical energy storage device 10 that is in the fast charging state and requires cooling can be cooled selectively and efficiently. In addition, preferably, the electrical energy storage device 10 that is in the fast charging state and requires heating can be heated selectively and efficiently. By regulating the temperature of the electrical energy storage device 10 on the fast charging within the predetermined temperature range in this manner, the generation of unevenness (bias) in salt concentration in the electrode assembly can be suppressed and the increase of the internal resistance can be suppressed. In addition, the reversible high-rate deterioration of the electrical energy storage device 10 can be suppressed suitably.

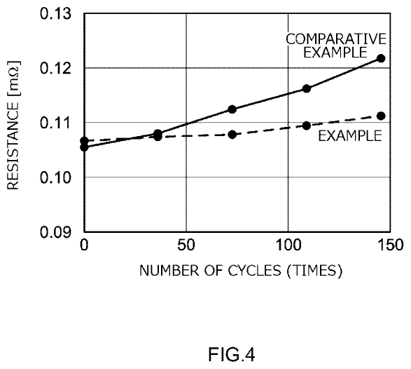

FIG. 4 is a graph showing transition of resistance in Comparative Example and Example when a cycle test is performed under a 25 °C environment using an electrical energy storage device of 200 Ah class. In this test, for each example, the electrical energy storage device was adjusted to have an SOC of 20%, charged with a constant current of 250 A for 400 seconds, and then discharged with a constant current of 40 A for 2500 seconds; this was regarded as one cycle and charging and discharging were repeated for a total of 140 cycles. Then, every 36 cycles, the electrical energy storage device was adjusted to have an SOC of 60% under the 25 °C environment and discharged with 240 A for 10 seconds; then, the IV resistance was measured. “Example” corresponds to the case in which the temperature control (specifically, air-cooling with a cooling fan) was performed in accordance with the flowchart in FIG. 3 using the art disclosed herein, for example. “Comparative Example” corresponds to the case in which the art disclosed herein was not employed (the temperature control was not performed). Performing the temperature control disclosed herein as described above can suppress the increase of the internal resistance suitably at the fast charging.

Although the embodiment of the present disclosure has been described above, the above-described embodiment is merely an example. The present disclosure can be implemented in various other modes. The present disclosure can be implemented based on the contents disclosed in the present specification and the technical common sense in the relevant field. The techniques described in the scope of claims include those in which the embodiments exemplified above are variously modified and changed.

For example, in the aforementioned embodiment in FIG. 3, the charging current I of the electrical energy storage device 10 is acquired in step S1 and whether the fast charting is currently performed is determined based on the charging current I (actual measurement value) in step S2. However, the present disclosure is not limited to this example. In a modification, it may be determined that the fast charting is currently performed in a case where, for example, the charging cable 310 is connected to a port for the fast charging of the electric vehicle 200 and a signal expressing the fast charging is received from the charging stand 300.

As described above, the following items are given as specific aspects of the art disclosed herein.

Item 1: A temperature control device for an electrical energy storage device, the temperature control device being electrically connected to a temperature regulation mechanism that regulates a temperature of the electrical energy storage device and including:
a first determination unit that determines whether the electrical energy storage device is on fast charging in which the charging is performed with a predetermined charging current or more;
a temperature acquisition unit that acquires the temperature of the electrical energy storage device;
a second determination unit that determines whether the temperature acquired by the temperature acquisition unit is more than a predetermined upper-limit temperature; and
a temperature control unit that causes the temperature regulation mechanism to cool the electrical energy storage device when both determination results of the first determination unit and the second determination unit are yes.

Item 2: The temperature control device for the electrical energy storage device according to Item 1, in which the first determination unit determines that the fast charging is currently performed when the charging current is 200 A or more.

Item 3: The temperature control device for the electrical energy storage device according to Item 1 or 2, further including a current acquisition unit that acquires the charging current of the electrical energy storage device, in which the first determination unit determines whether the fast charging is currently performed, based on the charging current acquired by the current acquisition unit.

Item 4: The temperature control device for the electrical energy storage device according to any one of Items 1 to 3, in which the upper-limit temperature is set in the range of 40±5 °C

Item 5: The temperature control device for the electrical energy storage device according to any one of Items 1 to 4, further including a third determination unit that determines whether the temperature acquired by the temperature acquisition unit is less than a predetermined lower-limit temperature, in which the temperature control unit causes the temperature regulation mechanism to heat the electrical energy storage device when where both determination results of the first determination unit and the third determination unit are yes.

Item 6: The temperature control device for the electrical energy storage device according to Item 5, in which the lower-limit temperature is set in the range of 10±5 °C.

Item 7: The temperature control device for the electrical energy storage device according to any one of Items 1 to 4, in which the temperature control unit does not drive the temperature regulation mechanism when at least one of the determination results of the first determination unit and the second determination unit is no.

Item 8: The temperature control device for the electrical energy storage device according to Item 5 or 6, in which the temperature control unit does not drive the temperature regulation mechanism when at least one of the determination results of the first determination unit and the third determination unit is no.

Item 9: A temperature control method for an electrical energy storage device in electric connection to a temperature regulation mechanism that regulates a temperature of the electrical energy storage device, the temperature control method including:
a first determining step of determining whether the electrical energy storage device is on fast charging in which the charging is performed with a predetermined charging current or more;
a temperature acquiring step of acquiring the temperature of the electrical energy storage device;
a second determining step of determining whether the temperature acquired by the temperature acquiring step is more than a predetermined upper-limit temperature; and
a temperature controlling step of causing the temperature regulation mechanism to cool the electrical energy storage device in the case where both determination results of the first determining step and the second determining step are yes.

What is claimed is:

1. A temperature control device for an electrical energy storage device, the temperature control device being electrically connected to a temperature regulation mechanism that regulates a temperature of the electrical energy storage device and comprising:
a first determination unit that determines whether the electrical energy storage device is on fast charging in which charging is performed with a predetermined charging current or more;
a temperature acquisition unit that acquires the temperature of the electrical energy storage device;
a second determination unit that determines whether the temperature acquired by the temperature acquisition unit is more than a predetermined upper-limit temperature; and
a temperature control unit that causes the temperature regulation mechanism to cool the electrical energy storage device when both determination results of the first determination unit and the second determination unit are yes.

2. The temperature control device according to claim 1, wherein the first determination unit determines that the fast charging is currently performed when the charging current is 200 A or more.

3. The temperature control device according to claim 2, further comprising a current acquisition unit that acquires the charging current of the electrical energy storage device, wherein the first determination unit determines whether the fast charging is currently performed, based on the charging current acquired by the current acquisition unit.

4. The temperature control device according to claim 1, wherein the upper-limit temperature is set in a range of 40±5 °C.

5. The temperature control device according to claim 1, further comprising a third determination unit that determines whether the temperature acquired by the temperature acquisition unit is less than a predetermined lower-limit temperature, wherein the temperature control unit causes the temperature regulation mechanism to heat the electrical energy storage device when both determination results of the first determination unit and the third determination unit are yes.

6. The temperature control device according to claim 5, wherein the lower-limit temperature is set in a range of 10±5 °C.

7. The temperature control device according to claim 1, wherein the temperature control unit does not drive the temperature regulation mechanism when at least one of the determination results of the first determination unit and the second determination unit is no.

8. The temperature control device according to claim 5, wherein the temperature control unit does not drive the temperature regulation mechanism when at least one of the determination results of the first determination unit and the third determination unit is no.

9. A temperature control method for an electrical energy storage device in electric connection to a temperature regulation mechanism that regulates a temperature of the electrical energy storage device, the temperature control method comprising:
a first determining step of determining whether the electrical energy storage device is on fast charging in which charging is performed with a predetermined charging current or more;
a temperature acquiring step of acquiring the temperature of the electrical energy storage device;
a second determining step of determining whether the temperature acquired by the temperature acquiring step is more than a predetermined upper-limit temperature; and
a temperature controlling step of causing the temperature regulation mechanism to cool the electrical energy storage device when both determination results of the first determining step and the second determining step are yes.
